(19) United States
(12) Patent Application Publication
(10) Pub. No.: US 2022/0327290 A1
(43) Pub. Date: Oct. 13, 2022

(54) METHOD OF TRAINING FEATURE DETERMINATION MODEL, METHOD OF PERFORMING SEMANTIC ANALYSIS, AND ELECTRONIC DEVICE

(71) Applicant: Beijing Baidu Netcom Science Technology Co., Ltd., Beijing (CN)

(72) Inventors: Junyuan SHANG, Beijing (CN); Shuohuan WANG, Beijing (CN); Siyu DING, Beijing (CN)

(21) Appl. No.: 17/852,413

(22) Filed: Jun. 29, 2022

(30) Foreign Application Priority Data
Jun. 30, 2021 (CN) 202110746978.2

(51) Int. Cl. G06F 40/30; G06N 3/08; G06N 3/04

(52) U.S. Cl. CPC G06F 40/30; G06N 3/08; G06N 3/04

(57) ABSTRACT

There is provided a method of training a feature determination model, which relates to a field of deep learning and natural language processing. The method is implemented to include: determining, by a plurality of feature determination layers arranged in stages, a feature vector for each segment in a pre-training text; and pre-training the feature determination model according to the feature vector. A current stage feature vector is determined by a feature determination layer of a current stage according to a preceding segment feature vector determined for a preceding segment, and a preceding stage feature vector determined by a feature determination layer of a preceding stage. A method of training a feature determination model for a target task, a method of performing semantic analysis for a target task, an electronic device, and a computer storage medium are also provided.

### CROSS-REFERENCE TO RELATED APPLICATIONS

This application is claims priority to Chinese Application No. 202110746978.2 filed on Jun. 30, 2021, which is incorporated herein by reference in its entirety.

### TECHNICAL FIELD

The present disclosure relates to a field of deep learning and natural language processing, in particular to a field of text analysis, and more specifically to a method of training a feature determination model, a method of training a feature determination model for a target task, a method of performing semantic analysis for a target task, an electronic device, and a computer storage medium.

### BACKGROUND

With the rapid development of the field of artificial intelligence, natural language processing technology, acting as the rock in the field of artificial intelligence, has received more and more attention. By training a model having a large amount of parameters based on massive text data with super computing power, the trained model may have a capability of understanding semantics generally under multiple tasks with few samples. However, due to a limited computing power of a system, it becomes difficult to adjust the parameters for such a large-scale model.

### SUMMARY

The present disclosure provides a method of training a feature determination model, a method of training a feature determination model for a target task, a method of performing semantic analysis for a target task, an electronic device, and a computer storage medium.

According to one aspect of the present disclosure, there is provided a method of pre-training a feature determination model. The feature determination model includes a plurality of feature determination layers arranged in stages, and the method includes:

determining, by the plurality of feature determination layers, a feature vector for each segment of a plurality of segments in a pre-training text; and

pre-training the feature determination model according to the feature vector,

where the determining, by the plurality of feature determination layers, a feature vector for each segment of a plurality of segments in a pre-training text includes: determining a current stage feature vector for one segment of the plurality of segments by a feature determination layer of a current stage, according to a preceding segment feature vector determined for a preceding segment of the one segment by the feature determination layer of the current stage, and a preceding stage feature vector determined for the one segment by a feature determination layer of a preceding stage of the current stage.

According to another aspect of the present disclosure, there is provided a method of training a feature determination model for a target task, including:

determining, by the feature determination model, a feature vector of a to-be-processed text;

predicting an analysis result of the to-be-processed text for the target task based on the feature vector of the to-be-processed text; and

adjusting the feature determination model based on the analysis result such that a loss value of the analysis result converges,

where the feature determination model includes a plurality of feature determination layers arranged in stages, and the to-be-processed text includes a plurality of segments; and

where the determining, by the feature determination model, a feature vector of a to-be-processed text includes: for one segment of the plurality of segments,

determining, by a feature determination layer of a current stage, a current stage feature vector for the one segment, according to a preceding segment feature vector determined for a preceding segment of the one segment by the feature determination layer of the current stage, and a preceding stage feature vector determined for the one segment by a feature determination layer of a preceding stage of the current stage.

According to yet another aspect of the present disclosure, there is provided a method of performing semantic analysis for a target task, including:

determining, by a feature determination model, a feature vector of a to-be-processed text; and

obtaining an analysis result of the to-be-processed text for the target task based on the feature vector of the to-be-processed text,

where the feature determination model is trained according to the method described in the above exemplary embodiment.

According to another aspect of the present disclosure, there is provided an electronic device, comprising: at least one processor; and a memory communicatively connected to the at least one processor, wherein the memory stores instructions executable by the at least one processor, and the instructions, when executed by the at least one processor, cause the at least one processor to implement the method described in the above exemplary embodiment.

According to another aspect of the present disclosure, there is provided a non-transitory computer-readable storage medium having computer instructions stored thereon, wherein the computer instructions allow a computer to implement the method described in the above exemplary embodiment.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The drawings are used to better understand the solution and do not constitute a limitation to the present disclosure. In the drawings:

FIG. 1 shows a flowchart of a method of pre-training a feature determination model according to an exemplary embodiment of the present disclosure;

FIG. 2A shows a schematic diagram of an example of a feature determination model according to an exemplary embodiment of the present disclosure;

FIG. 2B shows an exemplary schematic diagram of pre-training the feature determination model shown in FIG. 2A;

FIG. 3A shows a schematic diagram of another example of a feature determination model according to an exemplary embodiment of the present disclosure;

FIG. 3B shows an exemplary schematic diagram of pre-training the feature determination model shown in FIG. 3A;

FIG. 4 shows a flowchart of a method of training a feature determination model for a target task according to an exemplary embodiment of the present disclosure;

FIG. 5 shows a flowchart of a method of performing semantic analysis for a target task according to an exemplary embodiment of the present disclosure;

FIG. 6 shows a block diagram of an apparatus of pre-training a feature determination model according to an exemplary embodiment of the present disclosure;

FIG. 7 shows a block diagram of an apparatus of training a feature determination model for a target task according to an exemplary embodiment of the present disclosure;

FIG. 8 shows a block diagram of an apparatus for performing semantic analysis for a target task according to an exemplary embodiment of the present disclosure; and

FIG. 9 shows a block diagram of another example of an electronic device for implementing an embodiment of the present disclosure.

### DETAILED DESCRIPTION OF EMBODIMENTS

The exemplary embodiments of the present disclosure are described below with reference to the drawings, which include various details of the embodiments of the present disclosure to facilitate understanding, and which should be considered as merely illustrative. Therefore, those ordinary skilled in the art should realize that various changes and modifications may be made to the embodiments described herein without departing from the scope and spirit of the present disclosure. In addition, for clarity and conciseness, descriptions of well-known functions and structures are omitted in the following description.

By training a model having a large amount of parameters based on massive text data with super computing power, the pre-trained model may have a capability of understanding semantics generally under multiple tasks with few samples.

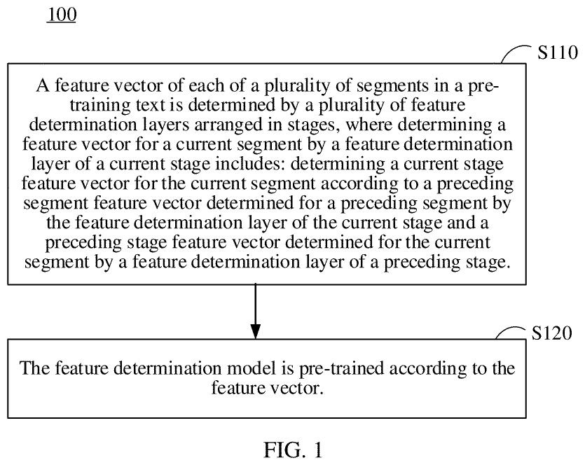

An exemplary embodiment of the present disclosure provides a method of pre-training a feature determination model. FIG. 1 shows a flowchart of a method of pre-training a feature determination model according to an exemplary embodiment of the present disclosure. The feature determination model may be a model including a plurality of feature determination layers arranged in stages, for example, an ERNIE-DOC model, a BERT model, etc. The plurality of feature determination layers may be a plurality of encoding layers for extracting feature vectors step by step.

As shown in FIG. 1, the method of pre-training the feature determination model 100 may include steps S110 and S120.

In step S110, a feature vector of each segment in a plurality of segments in the pre-training text is determined by a plurality of feature determination layers arranged in stages in the feature determination model. For example, the plurality of segments included in the pre-training text may be arranged in sequence and sequentially input into the plurality of feature determination layers of the feature determination model. The pre-training text may be unlabeled text data or weakly labeled text data. In other words, the pre-training text may be massive text data collected through various channels for various fields, instead of being training data prepared for a specific training target. By using the unlabeled text data or the weakly labeled text data in the training of the feature determination model, the feature determination model trained according to the the exemplary embodiment of the present disclosure has the general semantic analysis capability.

In an example, the step of determining the feature vector of each segment in the plurality of segments in the pre-training text by the plurality of feature determination layers in the feature determination model may include: determining a current stage feature vector for a current segment by a feature determination layer of a current stage, according to a preceding segment feature vector determined for a preceding segment of the current segment by the feature determination layer of the current stage and a preceding stage feature vector determined for the current segment by a feature determination layer of a preceding stage of the current stage.

For example, when a current stage feature vector for a current segment such as a p^{th} segment is determined by a feature determination layer of a current stage such as a feature determination layer of a q^{th} stage, the feature determination layer of the q^{th} stage may determine a q^{th} stage feature vector for the p^{th} segment, according to a preceding segment feature vector determined for a (p−1)^{th} segment by the feature determination layer of the q^{th} stage and a (q−1)^{th} stage feature vector determined for the p^{th} segment by a feature determination layer of a (q−1)^{th} stage, where 1<p≤M and 1<q≤N. M is the number of the plurality of segments, and N is the number of the plurality of feature determination layers. Although in this example, the preceding segment is exemplarily represented as a segment immediately preceding the current segment and the preceding stage is exemplarily represented as a stage immediately preceding the current stage, the present disclosure is not limited thereto. The preceding segment may be a segment spaced from the current segment by several segments, and the preceding stage may be a stage spaced from the current stage by several stages.

In step S120, the feature determination model is pre-trained according to the determined feature vectors. For example, the feature vectors may be predicted according to a preset decoding network corresponding to an encoding layer, so as to obtain a predicted analysis result corresponding to the feature vectors, so as to achieve the pre-training.

Since the current stage feature vector is determined based on both the preceding segment feature vector and the preceding stage feature vector, context may be considered by the feature determination model trained according to the training method of the exemplary embodiment of the present disclosure, so that the current stage feature vector may be determined in higher accuracy. In this way, it is possible to avoid manually inputting prompt words, thereby improving the efficiency and the accuracy.

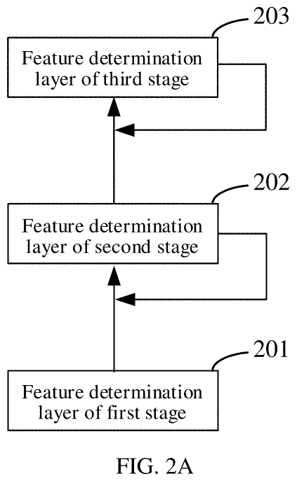

FIG. 2A shows a schematic diagram of an example of a feature determination model according to an exemplary embodiment of the present disclosure.

As shown in FIG. 2A, the feature determination model may include a plurality of feature determination layers arranged in stages, for example, a feature determination layer of a first stage 201, a feature determination layer of a second stage 202, and a feature determination layer of a third stage 203. It will be clear to those skilled in the art that, although the feature determination model is exemplarily shown in the specification as including feature determination layers arranged in three stages, the present disclosure is not limited thereto, and the feature determination model according to exemplary embodiments of the present disclosure may include more or less feature determination layers.

In addition, in the feature determination model shown in FIG. 2A, when determining the q^{th} stage feature vector for the p^{th} segment, the feature determination layer of the q^{th} stage may receive the (q−1)^{th} stage feature vector determined for the p^{th} segment by the feature determination layer of the (q−1)^{th} stage, and obtain the q^{th} stage feature vector determined for the (p−1)^{th} segment by the feature determination layer of the q^{th} stage, so that the q^{th} stage feature vector for the p^{th} segment is determined based on the two feature vectors, where 1<p≤M, 1<q≤N, and M is the number of the plurality of segments and N is the number of the feature determination layers. Accordingly, in the feature determination model shown in FIG. 2A, the feature determination layer of the current stage may determine the current stage feature vector for the current segment in consideration of its own memory regarding the feature vector of preceding segment.

FIG. 2B shows an exemplary schematic diagram of pre-training the feature determination model shown in FIG. 2A. As shown in FIG. 2B, the pre-training text 20 is first divided into a plurality of segments S1 to S4. The segments S1 to S4 may be short texts obtained by sliding and slicing the pre-training text 20 such as a long text. The segments S1 to S4 may be sequentially input into the feature determination model, so as to determine feature vectors corresponding to the segments S1 to S4. Those skilled in the art will understand that what is shown in FIG. 2B is only an example, and the embodiments of the present disclosure are not limited thereto.

For example, when the segment S1 is input into the feature determination model, first, the feature determination layer of the first stage 201 may obtain a first stage feature vector P(S1, 1) for the segment S1. Then, the feature determination layer of the second stage 202 may obtain a second stage feature vector P(S1, 2) based on the first stage feature vector P(S1, 1) obtained by the feature determination layer of the first stage 201. The feature determination layer of the third stage 203 may obtain a third stage feature vector P(S1, 3) based on the second stage feature vector P(S1, 2) obtained by the feature determination layer of the second stage 202.

When the segment S2 is input into the feature determination model, the feature determination layer of the first stage 201 may obtain a first stage feature vector P(S2, 1) for the segment S2. Then, the feature determination layer of the second stage 202 may obtain a second stage feature vector P(S2, 2) for the segment S2 based on the first stage feature vector P(S2, 1) (or referred to as “the preceding stage feature vector”) for the segment S2 and the second stage feature vector P(S1, 2) (or referred to as “the preceding segment feature vector”) for the segment S1; and the feature determination layer of the third stage 203 may obtain a third stage feature vector P(S2, 3) for the segment S2 based on the second stage feature vector P(S2, 2) for the segment S2 and the third stage feature vector P(S1, 3) for the segment S1.

Similarly, when the segment S3 is input into the feature determination model, the feature determination layer of the first stage 201 may obtain a first stage feature vector P(S3, 1) for the segment S3. Then, the feature determination layer of the second stage 202 may obtain a second stage feature vector P(S3, 2) for the segment S3 based on the first stage feature vector P(S3, 1) for the segment S3 and the second stage feature vector P(S2, 2) for the segment S2. The feature determination layer of the third stage 203 may obtain a third stage feature vector P(S3, 3) for the segment S3 based on the second stage feature vector P(S3, 2) for the segment S3 and the third stage feature vector P(S2, 3) for the segment S2.

When the segment S4 is input into the feature determination model, the feature determination layer of the first stage 201 may obtain a first stage feature vector P(S4, 1) for the segment S4. Then, the feature determination layer of the second stage 202 may obtain a second stage feature vector P(S4, 2) for the segment S4 based on the first stage feature vector P(S4, 1) for the segment S4 and the second stage feature vector P(S3, 2) for the segment S3. The feature determination layer of the third stage 203 may obtain a third stage feature vector P(S4, 3) for the segment S4 based on the second stage feature vector P(S4, 2) for the segment S4 and the third stage feature vector P(S3, 3) for the segment S3.

The third stage feature vector P(S4, 3) for the segment S4 obtained in the above-described manner may include information of all preceding segments. Therefore, the context may be considered by the feature determination model trained according to the training method described in the exemplary embodiment of the present disclosure, so that the current stage feature vector may be determined in higher accuracy. Therefore, it is possible to avoid manually inputting prompt words, thereby improving the efficiency and the accuracy.

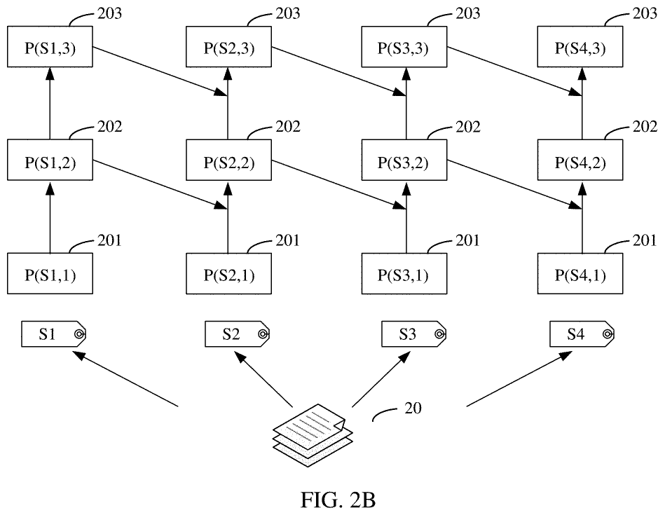

FIG. 3A shows a schematic diagram of another example of a feature determination model according to an exemplary embodiment of the present disclosure. Similar to FIG. 2A, the feature determination model shown in FIG. 3A may include a plurality of feature determination layers arranged in stages, for example, a feature determination layer of the first stage 301, a feature determination layer of the second stage 302, and a feature determination layer of the third stage 303.

Unlike the example shown in FIG. 2A, the feature determination model shown in FIG. 3A may additionally include a plurality of parameterized models, in order to applying parameterization to a list storing the feature vectors of the preceding segments. Accordingly, when the feature determination model needs to be adjusted, the feature determination model may be adjusted by adjusting parameters of the parameterized models. The list storing the feature vectors of the preceding segments may be referred to as a Memory structure. The parameterized models are used to parameterize the Memory structure, so that the feature determination model may be adjusted by adjusting the parameters of the parameterized models. In addition, by controlling a scale of the parameterized models, it is possible to adapt to a specific target task by adjusting only a few parameters of the parameterized models.

The parameterized model may be implemented as a variety of models such as a recurrent neural network (RNN) model or a transformer model.

Generally, in the feature determination model, a feature determination layer of a lower stage is able to learn a more general feature vector or more general knowledge, and a feature determination layer of a higher stage is able to learn a feature vector or knowledge related to a specific task. Accordingly, the parameterized models for different feature determination layers may be configured differently. For example, a parameterized model for a feature determination layer of a lower stage is designed to have fewer parameters, and a parameterized model for a feature determination layer of a higher stage is designed to have more parameters, so as to adapt to a variety of tasks without compromising the general semantic analysis capability of the feature determination model.

As shown in FIG. 3A, the plurality of parameterized models may include a first parameterized model 304 for the feature determination layer of the lower stage and a second parameterized model 305 for the feature determination layer of the higher stage. As described above, the first parameterized model 304 and the second parameterized model 305 may be configured differently. The first parameterized model 304 is configured to have fewer parameters, and the second parameterized model 305 is configured to have more parameters than the first parameterized model 304.

FIG. 3B shows an exemplary schematic diagram of pre-training the feature determination model shown in FIG. 3A. As shown in FIG. 3B, when a segment S1 of a pre-training text 30 is input into the feature determination model, a first stage feature vector P(S1, 1), a second stage feature vector P(S1, 2), and a third stage feature vector P(S1, 3) for the segment S1 may be obtained in a manner similar to that in FIG. 2B.

When a segment S2 is input into the feature determination model, a feature determination layer of a first stage 301 may obtain a first stage feature vector P(S2, 1) for the segment S2. Then, a feature determination layer of a second stage 302 may obtain a second stage feature vector P′(S2, 2) for the segment S2, based on the feature vector P(S2, 1) and a parameterization result P(S1, 2)_{P} of the second stage feature vector for the segment S1, which is obtained from the first parameterized model 304. A feature determination layer of a third stage 303 may obtain a third stage feature vector P′(S2, 3) for the segment S2 based on the second stage feature vector P′(S2, 2) for the segment S2, and from the second parameterized model 305, a parameterization result P(S1, 3)_{P} of the third stage feature vector for the segment S1.

Similarly, when a segment S3 is input into the feature determination model, the feature determination layer of the first stage 301 may obtain a first stage feature vector P(S3, 1) for the segment S3. The feature determination layer of the second stage 302 may obtain a second stage feature vector P′(S3, 2) for the segment S3 based on the feature vector P(S3, 1) and a parameterization result P(S2, 2)_{P}. The feature determination layer of the third stage 303 may obtain a third stage feature vector P′(S3, 3) for the segment S3 based on the feature vector P′(S3, 2) and a parameterization result P(S2, 3)_{P}.

When a segment S4 is input into the feature determination model, the feature determination layer of the first stage 301 may obtain a first stage feature vector P(S4, 1) for the segment S4; the feature determination layer of the second stage 302 may obtain a second stage feature vector P′(S4, 2) for the segment S4 based on the feature vector P(S4, 1) and a parameterization result P(S3, 2)_{P}. The feature determination layer of the third stage 303 may obtain a third stage feature vector P′(S4, 3) for the segment S4 based on the feature vector P′(S4, 2) and a parameterization result P(S3, 3)_{P}.

As described above, context is considered by the feature determination model trained according to the method described in the above exemplary embodiment, and adjusting of the feature determination model may be achieved by adjusting the parameters of the parameterized models such that the feature determination model may be adapted to a downstream task. In addition, it is possible to adjust the parameterized models to adapt to a specific target task by controlling a few parameters of the parameterized models.

In another example, the training method according to an exemplary embodiment of the present disclosure may further include: before a feature vector of a first segment of the plurality of segments is determined by the feature determination layers arranged in the plurality of stages, inserting a virtual segment as a preceding segment of the first segment, in order to allow the first segment to refer to the information of the preceding segment. In this case, a feature vector of the virtual segment may be determined by the plurality of feature determination layers. When determining the feature vector of the first segment in the plurality of segments by the plurality of feature determination layers, a current stage feature vector is determined for the first segment by a feature determination layer of a current stage, according to a virtual segment feature vector determined for the virtual segment by the feature determination layer of the current stage and a preceding stage feature vector determined for the first segment by a feature determination layer of a preceding stage. By providing the virtual segment, it is possible to use the information of the preceding segment for the first segment, so that input paradigms of pre-training and fine-tuning may be unified.

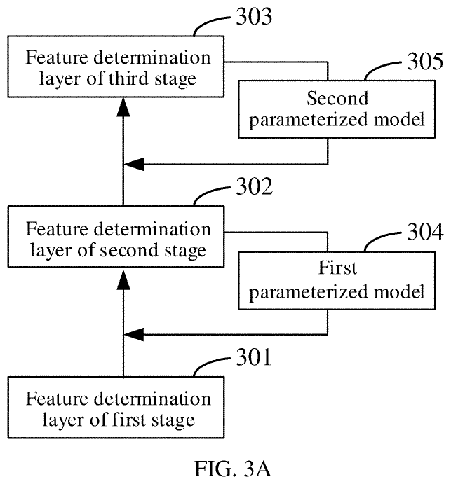

An exemplary embodiment of the present disclosure further provides a method of training a feature determination model for a target task. FIG. 4 shows a flowchart of a method of training a feature determination model for a target task according to an exemplary embodiment of the present disclosure.

As shown in FIG. 4, the method 400 may include the following steps.

In step S410, a feature vectors of a to-be-processed text is determined by the feature determination model. As described above, the feature determination model includes the plurality of feature determination layers arranged in stages, and the to-be-processed text includes a plurality of segments. The plurality of segments are arranged in sequence and are sequentially input into the feature determination model.

When determining a current stage feature vector for a certain segment by a feature determination layer of a current stage, the current stage feature vector for the segment may be determined according to a preceding segment feature vector determined for a preceding segment by the feature determination layer of the current stage and a preceding stage feature vector determined for the segment by a feature determination layer of a preceding stage. For example, when determining a q^{th} stage feature vector for a p^{th} segment by a feature determination layer of a q^{th} stage, the q^{th} stage feature vector for the p^{th} segment may be determined according to a q^{th} stage feature vector determined for a (p−1)^{th} segment by the feature determination layer of the q^{th} stage and a (q−1)^{th} stage feature vector determined for the p^{th} segment by a feature determination layer of a (q−1)^{th} stage, where 1<p≤M and 1<q≤N, M is the number of plurality of segments, and N is the number of the plurality of feature determination layers.

In another example, when the feature determination model further includes the parameterized models, the parameterized models may further apply parameterization to the preceding segment feature vector to obtain a parameterization result of the preceding segment feature vector. The current stage feature vector for the segment is determined according to the parameterization result and the preceding stage feature vector.

In step S420, an analysis result of the to-be-processed text for a target task is predicted based on the feature vector of the to-be-processed text. For example, the feature vectors of the to-be-processed text may be analyzed by an analysis model for the target task, so as to predict the analysis result of the to-be-processed text for the target task.

In step S430, the feature determination model is adjusted based on the analysis result, such that a predicted loss value of the analysis result converges. For example, in a case where the feature determination model further includes a parameterized model such as a Recurrent Neural Network (RNN) model or a Transformer model, the parameterization result may be adjusted by adjusting weights in the RNN model or the transformer model based on the analysis result. Thus, the current stage feature vector determined for the segment by the feature determination layer of the current stage is changed, achieving the purpose of adjusting the feature determination model to adapt to a downstream target task.

In another example, the training method according to an exemplary embodiment of the present disclosure may additionally include: inserting a virtual segment before a feature vector of a first segment of the plurality of segments is determined by the feature determination layers arranged in the plurality of stages; and a feature vector for the virtual segment is determined by the plurality of feature determination layers. In this case, when the feature vector of the first segment of the plurality of segments is determined by the plurality of feature determination layers, the feature determination layer of the current stage may determine a current stage feature vector for the first segment according to a virtual segment feature vector determined for the virtual segment by the feature determination layer of the current stage and a preceding stage feature vector determined for the first segment by the feature determination layer of a preceding stage.

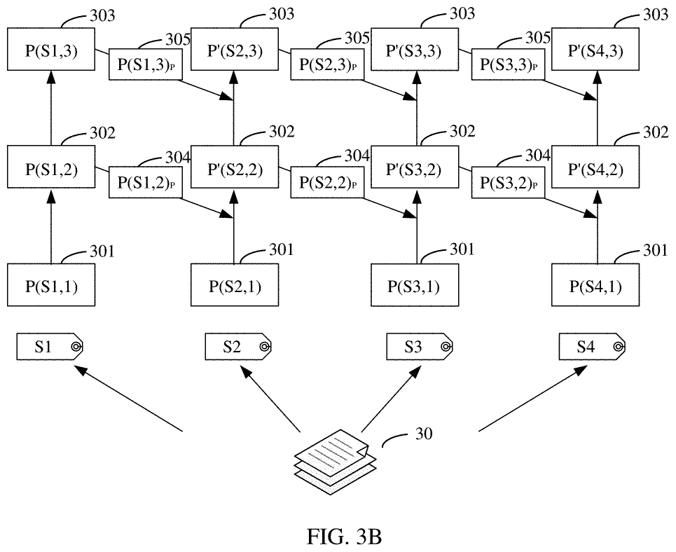

The method for training the feature determination model for the target task is described above. By determining the current stage feature vector based on both the preceding segment feature vector and the preceding stage feature vector in combination with the target task, the context may be considered by the feature determination model trained according to the method described in the exemplary embodiment of the present disclosure, so as to achieve a quick convergence for the specific target task. Furthermore, by adjusting the feature determination model through the parameterized models, it is possible to reduce the amount of parameters that need to be adjusted, thereby facilitating the adaptation of the feature determination model to a specific target task without destroying the original model structure. In addition, by providing the virtual segment, the training method according to the exemplary embodiment of the present disclosure may maintain the consistency of a pre-training input and a fine-tuning input. An exemplary embodiment according to the present disclosure further provides a method of performing semantic analysis for a target task. FIG. 5 shows a flowchart of a method of performing semantic analysis for a target task according to an exemplary embodiment of the present disclosure. As shown in FIG. 5, the method 500 of performing semantic analysis for a target task according to an exemplary embodiment of the present disclosure may include the following steps.

In step S510, a feature vector of a to-be-processed text is determined by a feature determination model.

In step S520, an analysis result of the to-be-processed text for the target task is obtained based on the feature vector of the to-be-processed text. The feature determination model is trained according to the method described in the above exemplary embodiment of the present disclosure.

With the method of performing semantic analysis for the target task according to the exemplary embodiments of the present disclosure, the current stage feature vector is determined based on both the preceding segment feature vector and the preceding stage feature vector in conjunction with the target task, such that the context is considered, thereby obtaining a more accurate analysis result.

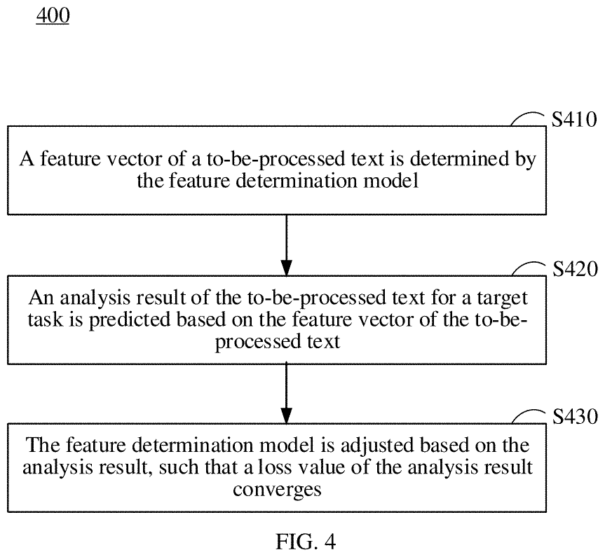

In addition, an exemplary embodiment of the present disclosure further provides an apparatus for pre-training a feature determination model. FIG. 6 shows a block diagram of an apparatus for pre-training a feature determination model according to an exemplary embodiment of the present disclosure. The feature determination model may be a model including a plurality of feature determination layers arranged in stages, for example, an ERNIE-DOC model, a BERT model, etc. The plurality of feature determination layers may be a plurality of coding layers for extracting feature vectors step by step.

As shown in FIG. 6, the apparatus 600 may include a feature vector determination module 610 and a pre-training module 620.

The feature vector determination module 610 may be configured to determine a feature vector for each segment of a plurality of segments in the pre-training text by the plurality of feature determination layers. The plurality of segments in the pre-training text may be arranged in sequence and are sequentially input into the plurality of feature determination layers of the feature determination model. The pre-training text may be unlabeled text data or weakly labeled text data. In other words, the pre-training text may be massive text data collected through various channels for various fields, instead of being training data prepared for a specific training target.

The pre-training module 620 may be configured to pre-train the feature determination model according to the determined feature vector. For example, the feature vector may be predicted according to a preset decoding network corresponding to encoding layers, so as to obtain a prediction analysis result corresponding to the feature vector.

In one example, the feature vector determination module 610 may be further configured to: determine a current stage feature vector for the segment by a feature determination layer of a current stage, according to a preceding segment feature vector determined for a preceding segment of the segment by the feature determination layer of the current stage and a preceding stage feature vector determined for the segment by a feature determination layer of a preceding stage of the current stage. For example, when determining a current stage feature vector for a current segment such as a p^{th} segment by the feature determination layer of the current stage such as a feature determination layer of a q^{th} stage, the feature determination layer of the q^{th} stage may determine the q^{th} stage feature vector for the p^{th} segment, according to a preceding segment feature vector determined for a (p−1)^{th} segment by the feature determination layer of the q^{th} stage and a (q−1)^{th} stage feature vector determined for the p^{th} segment by a feature determination layer of a (q−1)^{th} stage, where 1<p≤M and 1<q≤N, M is the number of the plurality of segments, and N is the number of the feature determination layers.

In another example, when the feature determination model additionally includes a plurality of parameterized models for parameterizing a list storing feature vectors of preceding segments, the feature vector determination module 610 may be further configured to: apply parameterization to the preceding segment feature vector by the parameterization models to obtain a parameterization result for the preceding segment feature vector; and determine the current stage feature vector for the segment according to the parameterization result and the preceding stage feature vector.

As mentioned above, context is considered by the feature determination model trained by the device according to the above exemplary embodiment, while the adjusting of the feature determination model may be achieved by adjusting the parameters of the parameterized models such that the feature determination model may be adapted to a downstream task. Furthermore, the feature determination model may be adjusted to adapt to a specific target task by controlling a few parameters of the parameterized models.

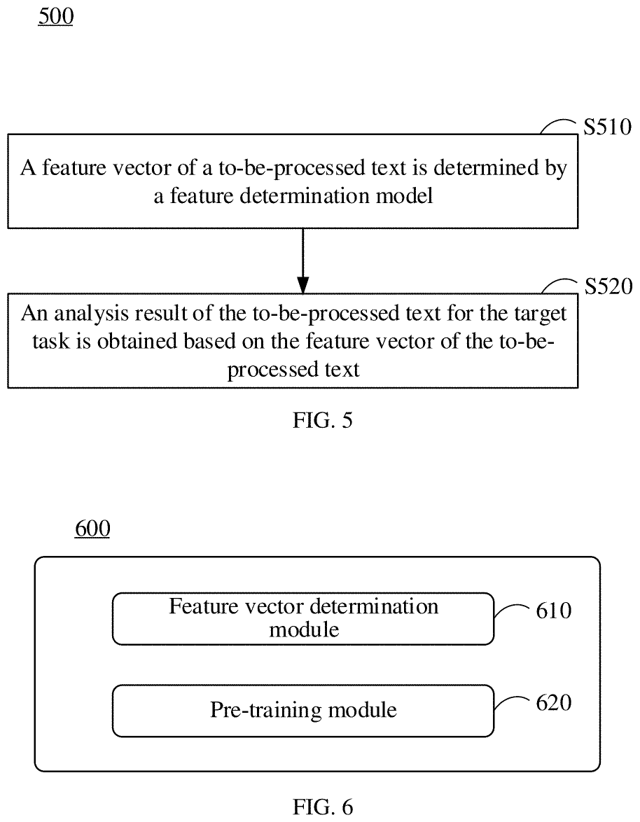

An exemplary embodiment of the present disclosure further provides an apparatus for training a feature determination model for a target task. FIG. 7 shows a block diagram of an apparatus for training a feature determination model for a target task according to an exemplary embodiment of the present disclosure. The feature determination model includes a plurality of feature determination layers arranged in stages, and a to-be-processed text includes a plurality of segments.

The apparatus 700 may include a feature vector determination module 710, an analysis result predicting module 720, and an adjustment module 730.

The feature vector determination module 710 may be configured to determine a feature vector of the to-be-processed text by the feature determination model. The feature vector determination module 710 may be further configured to: determine a current stage feature vector for a current segment by a feature determination layer of a current stage, according to a preceding segment feature vector determined for a preceding segment of the current segment by the feature determination layer of the current stage and a preceding stage feature vector determined for the segment by a feature determination layer of a preceding stage of the current stage. In another example, when the feature determination model further includes parameterized models, the feature vector determination module 710 may further apply parameterization to the preceding segment feature vector by the parameterized models, so as to obtain a parameterization result for the preceding segment feature vector, and the current stage feature vector for the current segment is determined according to the parameterization result and the preceding stage feature vector.

The analysis result predicting module 720 may be configured to predict an analysis result of the to-be-processed text for the target task based on the feature vector of the to-be-processed text. For example, the feature vector(s) of the to-be-processed text may be analyzed by using an analysis model for the target task, so as to predict the analysis result of the to-be-processed text for the target task.

The adjustment module 730 may be configured to adjust the feature determination model based on the predicted analysis results such that a loss value of the analysis result converges. For example, in the case where the feature determination model further includes the parameterized models, weights in the recurrent neural network (RNN) model or the transformer model may be adjusted based on the analysis result, so that a parameterization result may be adjusted. Accordingly, the current stage feature vector determined by the feature determination layer of the current stage for the current segment is changed, achieving the purpose of adjusting the feature determination model to adapt to a downstream target task.

The apparatus for training a feature determination model for a target task is described above. By determining the current stage feature vector based on both the preceding segment feature vector and the preceding stage feature vector in combination with the target task, context information may be considered by the feature determination model trained by the apparatus according to the exemplary embodiments of the present disclosure, so as to achieve a quick convergence. Furthermore, adjusting the feature determination model through the parameterized models may reduce the amount of parameters that need to be adjusted, thereby facilitating the adaptation of the feature determination model to a specific target task without destroying the original model structure.

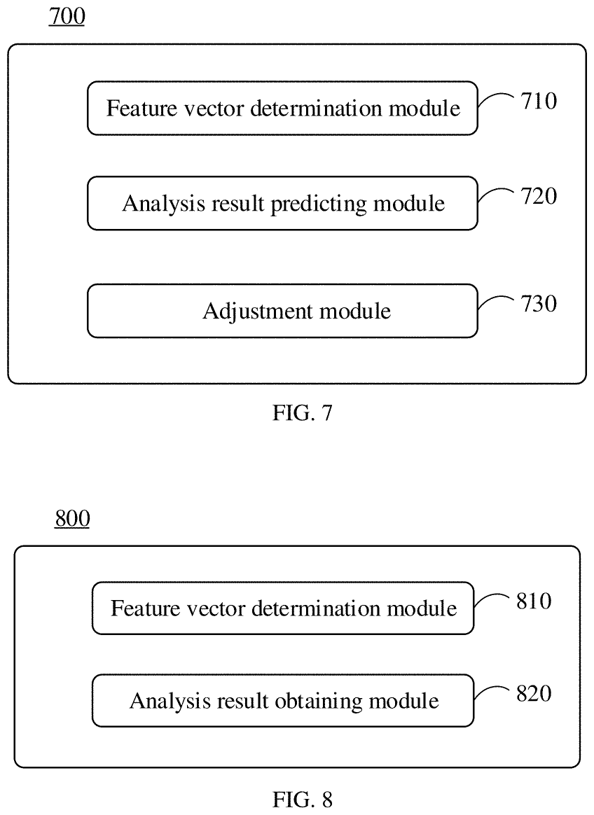

An exemplary embodiment of the present disclosure further provides an apparatus for performing semantic analysis for a target task. FIG. 8 shows a block diagram of an apparatus for performing semantic analysis for a target task according to an exemplary embodiment of the present disclosure.

As shown in FIG. 8, the apparatus 800 may include: a feature vector determination module 810 and an analysis result obtaining module 820.

The feature vector determination module 810 may be configured to determine a feature vector of a to-be-processed text by a feature determination model. The analysis result obtaining module 820 may be configured to obtain an analysis result of the to-be-processed text for the target task based on the feature vector of the to-be-processed text, where the feature determination model is trained according to the method described in the above exemplary embodiments of the present disclosure.

With the apparatus for performing semantic analysis for the target task according to the exemplary embodiment of the present disclosure, the current stage feature vector is determined based on both the preceding segment feature vector and the preceding stage feature vector in combination with the target task, such that the context information is considered, so as to obtain a more accurate analysis result.

Collecting, storing, using, processing, transmitting, providing, and disclosing etc. of the personal information of the user involved in the present disclosure all comply with the relevant laws and regulations, are protected by essential security measures, and do not violate the public order and morals. According to the present disclosure, personal information of the user is acquired or collected after such acquirement or collection is authorized or permitted by the user.

According to an embodiment of the present disclosure, an electronic device, a readable storage medium, and a computer program product is further provided.

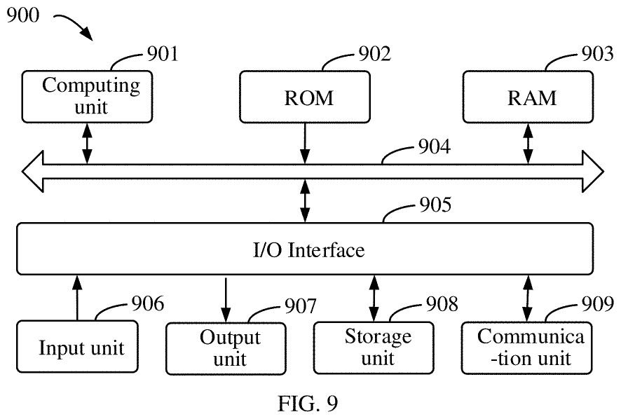

FIG. 9 shows a schematic block diagram of an exemplary electronic device 900 that can be used for implementing an embodiment of the present disclosure. An Electronic device is intended to represent various forms of digital computers, such as laptops, desktops, workstations, personal digital assistants, servers, blade servers, mainframe computers, and other suitable computers. The Electronic device may also represent various forms of mobile devices, such as personal digital processors, cellular phones, smart phones, wearable devices, and other similar computing devices. The components, the connections and relationships thereof, and the functions thereof shown herein are by way of example only, and are not intended to limit implementations of the disclosure described and/or claimed herein.

As shown in FIG. 9, a device 900 includes a computing unit 901 that can perform various appropriate actions and processes according to a computer program stored in a read only memory (ROM) 902 or a computer program loaded into a random access memory (RAM) 903 from the storage unit 908. In the RAM 903, various programs and data necessary for the operation of the device 900 may further be stored. The computing unit 901, the ROM 902, and the RAM 903 are connected to each other through a bus 904. An input/output (I/O) interface 905 is further connected to the bus 904.

A plurality of components in the device 900 are connected to the I/O interface 905, and the plurality of components include: an input unit 906, such as a keyboard, a mouse, etc.; an output unit 907, such as various types of displays, speakers, etc.; a storage unit 908, such as a magnetic disk, an optical disk, etc.; and a communication unit 909, such as a network card, a modem, a wireless communication transceiver, etc. The communication unit 909 allows the device 900 to exchange information/data with other devices through a computer network such as the Internet and/or various telecommunication networks.

The computing unit 901 may be various general-purpose and/or special-purpose processing components with processing and computing capabilities. Some examples of the computing units 901 include, but are not limited to, central processing units (CPUs), graphics processing units (GPUs), various specialized artificial intelligence (AI) computing chips, various computing units that run machine learning model algorithms, digital signal processing processors (DSPs), and any suitable processor, controller, microcontroller, etc. The computing unit 901 performs the methods and steps described above, for example, the methods and steps shown in FIGS. 2A to 5. For example, in some embodiments, the methods and steps shown in FIGS. 2A to 5 may be implemented as a computer software program tangibly embodied on a machine-readable medium, such as the storage unit 908. In some embodiments, part of or all of the computer program may be loaded and/or installed on the device 900 via the ROM 902 and/or the communication unit 909. When a computer program is loaded into the RAM 903 and executed by the computing unit 901, one or more steps of the methods described above may be performed. Alternatively, in some other embodiments, the computing unit 901 may be configured to perform the methods and steps described above by any other suitable means (e.g., by means of firmware).

Herein, various implementations of the systems and techniques described above can be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), a computer hardware, firmware, software, and/or combinations thereof. These various implementations may include being implemented in one or more computer programs, where the one or more computer programs can be executed and/or interpreted on a programmable system including at least one programmable processor. The programmable processor, which may be a special purpose or general purpose programmable processor, receives data and instructions from a storage system, at least one input device, and at least one output device, and transmits the data and the instructions to the storage system, the at least one input device, and the at least one output device.

Program codes for implementing the method of the present disclosure may be written in any combination of one or more programming languages. These program codes may be provided to a processor or a controller of a general purpose computer, a special purpose computer or other programmable data processing apparatus, such that the program codes, when executed by the processor or the controller, causes the functions/operations specified in the flowcharts and/or the block diagrams to be performed. The program codes may be executed entirely on the machine, partly on the machine, partly on the machine and partly on a remote machine as a stand-alone software package or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable media may include, but are not limited to, electronic, magnetic, optical, electromagnetic, infrared, or semiconductor systems, devices, or devices, or any suitable combination of the foregoing. More specific examples of the machine-readable storage media may include electrical connections based on one or more wires, portable computer disks, hard disks, random access memories (RAMs), read only memories (ROMs), erasable programmable read only memories (EPROMs or flash memories), optical fibers, portable compact disk read only memories (CD-ROMs), optical storage devices, magnetic storage devices, or any suitable combination of the foregoing.

In order to provide interaction with a user, the systems and techniques described herein may be implemented on a computer having a display device (e.g., a CRT (cathode ray tube) or a LCD (liquid crystal display) monitor) for displaying information to the user; and a keyboard and a pointing device (e.g., a mouse or a trackball) through which the user can provide input to the computer. Other kinds of devices may also be used to provide interaction with the user; for example, the feedback provided to the user may be sensory feedback in any form (e.g., the visual feedback, the auditory feedback, or the tactile feedback), and the input from the user may be received in any form (including the acoustic input, the voice input, or the tactile input).

The systems and techniques described herein may be implemented on a computing system that includes back-end components (e.g., as a data server), or a computing system that includes middleware components (e.g., an application server), or a computing system that includes front-end components (e.g., a user's computer having a graphical user interface or a web browser through which the user may interact with the implementations of the systems and techniques described herein), or a computing system that includes any combination of such back-end components, middleware components, or front-end components. The components of the system may be interconnected by any form or medium of digital data communication (e.g., a communication network). Examples of the communication network include: Local Area Networks (LANs), Wide Area Networks (WANs), and the Internet.

A computer system may include a client and a server. Clients and servers are generally remote from each other and usually interact through a communication network. The relationship of the client and the server arises by computer programs running on respective computers and having a client-server relationship to each other. The server may be a cloud server, a server of a distributed system, or a server combined with a block chain.

It should be understood that steps of the processes illustrated above may be reordered, added or deleted in various manners. For example, the steps described in the present disclosure may be performed in parallel, performed sequentially, or performed in a different order, as long as a desired result of the technical solution of the present disclosure may be achieved, which is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of pre-training a feature determination model, the feature determination model comprising a plurality of feature determination layers arranged in stages, the method comprising:
determining, by the plurality of feature determination layers, a feature vector for each segment of a plurality of segments in a pre-training text; and
pre-training the feature determination model according to the feature vector,
wherein the determining, by the plurality of feature determination layers, a feature vector for each segment of a plurality of segments in a pre-training text comprises: determining a current stage feature vector for one segment of the plurality of segments by a feature determination layer of a current stage, according to a preceding segment feature vector determined for a preceding segment of the one segment by the feature determination layer of the current stage, and a preceding stage feature vector determined for the one segment by a feature determination layer of a preceding stage of the current stage.

2. The method of claim 1, wherein the determining a current stage feature vector for the one segment comprises:
applying, by a recurrent neural network RNN model or a transformer model, parameterization to the preceding segment feature vector to obtain a parameterized result for the preceding segment feature vector; and
determining the current stage feature vector for the one segment according to the parameterized result and the preceding stage feature vector.

3. The method of claim 1, wherein the determining a current stage feature vector for the one segment comprises:
determining, by a feature determination layer of a q^{th} stage, a current stage feature vector for a p^{th} segment, according to a preceding segment feature vector determined for a (p−1)^{th} segment by the feature determination layer of the q^{th} stage and a preceding stage feature vector determined for the p^{th} segment by a feature determination layer of a (q−1)^{th} stage, wherein 1<p≤M and 1<q≤N, M is the number of the plurality of segments, and N is the number of the feature determination layers.

4. The method of claim 1, further comprising:
inserting a virtual segment before determining, by the plurality of feature determination layers, a feature vector for a first segment of the plurality of segments; and
determining, by the plurality of feature determination layers, a feature vector for the virtual segment,
wherein the determining, by the plurality of feature determination layers, a feature vector for a first segment of the plurality of segments comprising: determining, by the feature determination layer of the current stage, a current stage feature vector for the first segment, according to a virtual segment feature vector determined for the virtual segment by the feature determination layer of the current stage, and a preceding stage feature vector determined for the first segment by the feature determination layer of the preceding stage.

5. The method of claim 1, wherein the plurality of segments are arranged in sequence.

6. A method of training a feature determination model for a target task, comprising:
determining, by the feature determination model, a feature vector of a to-be-processed text;
predicting an analysis result of the to-be-processed text for the target task based on the feature vector of the to-be-processed text; and
adjusting the feature determination model based on the analysis result such that a loss value of the analysis result converges,
wherein the feature determination model comprises a plurality of feature determination layers arranged in stages, and the to-be-processed text comprises a plurality of segments; and
wherein the determining, by the feature determination model, a feature vector of a to-be-processed text comprises: for one segment of the plurality of segments,
determining, by a feature determination layer of a current stage, a current stage feature vector for the one segment, according to a preceding segment feature vector determined for a preceding segment of the one segment by the feature determination layer of the current stage, and a preceding stage feature vector determined for the one segment by a feature determination layer of a preceding stage of the current stage.

7. The method of claim 6, wherein the determining a current stage feature vector for the one segment comprises:
applying, by a recurrent neural network RNN model or a transformer model, parameterization to the preceding segment feature vector to obtain a parameterized result of the preceding segment feature vector; and
determining the current stage feature vector for the one segment according to the parameterized result and the preceding stage feature vector.

8. The method of claim 7, wherein the adjusting the feature determination model based on the analysis result such that a loss value of the analysis result converges comprises:
adjusting the parameterized result by adjusting a weight in the recurrent neural network RNN model or the transformer model based on the analysis result, so as to change the current stage feature vector determined for the one segment by the feature determination layer of the current stage.

9. The method of claim 6, wherein the determining a current stage feature vector for the one segment comprises:
determining, by a feature determination layer of a q^{th} stage, a current stage feature vector for a p^{th} segment, according to a preceding segment feature vector determined for a (p−1)^{th} segment by the feature determination layer of the q^{th} stage and a preceding stage feature vector determined for the p^{th} segment by a feature determination layer of a (q−1)^{th} stage, wherein 1<p≤M and 1<q≤N, M is the number of the plurality of segments, and N is the number of the feature determination layers.

10. The method of claim 6, further comprising:
inserting a virtual segment before determining, by the plurality of feature determination layers, a feature vector for a first segment of the plurality of segments; and
determining, by the plurality of feature determination layers, a feature vector for the virtual segment,
wherein the determining, by the plurality of feature determination layers, a feature vector for a first segment of the plurality of segments comprising: determining, by the feature determination layer of the current stage, a current stage feature vector for the first segment, according to a virtual segment feature vector determined for the virtual segment by the feature determination layer of the current stage and a preceding stage feature vector determined for the first segment by the feature determination layer of the preceding stage.

11. The method of claim 6, wherein the plurality of segments are arranged in sequence.

12. A method of performing semantic analysis for a target task, comprising:
determining, by a feature determination model, a feature vector of a to-be-processed text; and
obtaining an analysis result of the to-be-processed text for the target task based on the feature vector of the to-be-processed text,
wherein the feature determination model is trained according to the method of claim 6.

13. The method of claim 12, wherein the determining a current stage feature vector for the one segment comprises:
applying, by a recurrent neural network RNN model or a transformer model, parameterization to the preceding segment feature vector to obtain a parameterized result of the preceding segment feature vector; and
determining the current stage feature vector for the one segment according to the parameterized result and the preceding stage feature vector.

14. The method of claim 13, wherein the adjusting the feature determination model based on the analysis result such that a loss value of the analysis result converges comprises:
adjusting the parameterized result by adjusting a weight in the recurrent neural network RNN model or the transformer model based on the analysis result, so as to change the current stage feature vector determined for the one segment by the feature determination layer of the current stage.

15. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

16. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 6.

17. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 12.

18. A non-transitory computer-readable storage medium having computer instructions stored thereon, wherein the computer instructions allow a computer to implement the method of claim 1.

19. A non-transitory computer-readable storage medium having computer instructions stored thereon, wherein the computer instructions allow a computer to implement the method of claim 6.

20. A non-transitory computer-readable storage medium having computer instructions stored thereon, wherein the computer instructions allow a computer to implement the method of claim 12.
